(19) United States
(12) Patent Application Publication
(10) Pub. No.: US 2024/0019151 A1
(43) Pub. Date: Jan. 18, 2024

(54) Unmanned inspection system and method of HVAC room based on artificial intelligence

(71) Applicants: Tianjin Chengjian University, Tianjin (CN); Xi'an University of Architecture and Technology, Xi'an City (CN)

(72) Inventors: Bin Yang, Tianjin (CN); Lingge Chen, Tianjin (CN); Xiaojing Li, Tianjin (CN)

(21) Appl. No.: 18/132,030

(22) Filed: Apr. 7, 2023

(30) Foreign Application Priority Data
Jul. 14, 2022 (CN) 202210827559.6

(51) Int. Cl. F24F 11/52; F24F 11/58; B25J 19/02

(52) U.S. Cl. CPC F24F 11/52; F24F 11/58; B25J 19/023

(57) ABSTRACT

The invention relates to an unmanned inspection system and method for HVAC room based on artificial intelligence, which comprises a patrol robot, a motion unit, a mechanical room inspection unit, a fault diagnosis unit, a fault alarm unit and a terminal report unit. The motion unit is used to realize the automatic driving. The mechanical room inspection unit is used to detect the environmental information and the running status of the equipment in the HVAC room. The fault diagnosis unit is used to receive the environmental information and equipment running status and compare the received information with the preset conditions. According to the comparison results, it is judged whether there is a fault. If there is a fault, the fault alarm unit alert the fault information. The invention can realize unmanned automatic inspection, lighten the workload of personnel, and improve the efficiency and accuracy of patrol work.

### FIELD OF THE INVENTION

The invention relates to the technical field of mechanical room inspection, in particular to an unmanned inspection system and method of HVAC room based on artificial intelligence.

### BACKGROUND TECHNOLOGY

With the rapid development of China's economy, people's life has been greatly improved, so the requirements for the quality of life are also gradually improved, and the requirements for buildings are no longer so simple to provide living space. Instead, there are higher requirements for indoor temperature and humidity and other comfort conditions. The regulation and control of indoor temperature and humidity makes the use of central air conditioning more common, and requires higher precision of central air conditioning regulation. There are many contents in the design of HVAC, such as heating, cooling, ventilation and so on. All kinds of equipment involved in these systems, such as water chillers, pumps, water separators, water tanks, valves and so on, are placed in the air-conditioning room. Therefore, the air-conditioning room is a vital part of the whole system, in the core position. Once the ambient temperature and equipment in the air conditioning room break down, it will lead to problems in the operation of the whole system. For example, if the temperature in the air-conditioning room is too high, it may damage the electronic equipment in the room. If the temperature is too low, it may lead to insensitive operation of the equipment. If the humidity in the air-conditioning room is too high, it may lead to condensation. If the humidity is too low, it may lead to electrostatic discharge problems, thus damaging components. If the refrigeration unit fails, it may lead to problems in the operation of the air-conditioning system, unable to accurately control the indoor temperature and humidity. Regular inspection of the mechanical room can timely find the problems existing in the environment and equipment operation in the mechanical room, so as to eliminate the faults in time, eliminate the hidden dangers, avoid affecting the operation of the whole system, and ensure that the system is always in a safe and stable operation state. Therefore, it is necessary to carry out real-time inspection of the air-conditioning room in order to grasp the operation status of the equipment and the changes of the surrounding environment, and find out all kinds of hidden dangers in the operation of the equipment in time, so as to ensure the safe and normal operation of the equipment in the air-conditioning room and maintain the normal operation of the HVAC system.

At present, the patrol work of the mechanical room is still in the state of manual inspection, which consumes a lot of human resources, and has the advantages of high labor cost, low work efficiency and long inspection cycle. Because of the large number of equipment in the mechanical room, it has the characteristics of a large number of inspection objects, high frequency, repetitive and boring inspection work in the daily inspection process. The timeliness of manual inspection is greatly affected by the physical strength, working ability, sense of responsibility and other factors, so missed inspection or false inspection often occurs in the process of inspection. In addition, due to the high labor cost and labor intensity, manual inspection cannot achieve 24-hour real-time detection, so when there is a fault in the mechanical room, it is easy to fail to alarm in time, lack of risk early warning and other problems. At the same time, there are many plumbing equipment in the mechanical room, the road conditions are complex, and the space in some areas is narrow, which makes it difficult for inspectors to inspect. INVENT CONTENT

In order to solve the problems of the existing technology, the invention provides an unmanned inspection system and method for HVAC room based on artificial intelligence, which can replace manual work for daily inspection and realize unmanned automatic inspection, which can not only reduce the workload of personnel, save a lot of manpower and material resources, but also improve the efficiency and accuracy of inspection work.

The invention is realized by the following technical proposal:

An unmanned inspection system for HVAC room based on artificial intelligence includes a patrol robot, a motion unit, a mechanical room inspection unit, a fault diagnosis unit, a fault alarm unit and a terminal report unit. The motion unit, the mechanical room inspection unit and the fault diagnosis unit are installed on the patrol robot, and the fault alarm unit is installed in the HVAC room. The terminal report unit is installed on the terminal equipment.

The motion unit is used to realize the automatic driving of the inspection robot.

The mechanical room inspection unit is used to detect the environmental information and the running status of the equipment in the HVAC room and send it to the fault diagnosis unit.

The fault diagnosis unit is used for receiving the environmental information and equipment running state detected by the mechanical room patrol inspection unit, and comparing the received environmental information with the preset environmental conditions. The operation state of the received equipment is compared with the preset equipment operation state, and whether there is a fault in the HVAC room is judged according to the comparison result. if there is a fault, the fault information is obtained and sent to the fault alarm unit.

The fault alarm unit is used for alerting the fault information.

Preferably, the motion unit includes a motion control unit, a camera, a lidar, a GPS and an inertial sensor.

The camera is used for collecting indoor images of the HVAC room.

The lidar is used to detect the shape of the object in the HVAC room, and the indoor map is constructed according to the indoor image captured by the camera.

GPS is used to collect position information of patrol robot.

Inertial Sensor is used to measure the motion data of Patrol Robot during motion.

The motion control unit adopts a three-dimensional obstacle avoidance algorithm, and carries out path planning according to the indoor map constructed by lidar, the position information of the patrol robot collected by GPS and the motion data of the patrol robot measured by inertial sensors, so that the patrol robot can drive automatically.

Preferably, the mechanical inspection unit of the room includes an environment detection module and an equipment detection module.

The environment detection module is used to detect the temperature, humidity, gas and noise information in the HVAC room, and get the environmental information.

The equipment detection module is used to detect the operation status of the equipment in the HVAC room, including the equipment indicator status, the equipment switch status, the equipment dashboard data and the equipment surface temperature.

The equipment detection module includes an infrared thermal imager.

The infrared thermal imager is mounted on the inspection robot and is used to measure the surface temperature of the equipment.

The fault diagnosis unit includes an environment diagnosis module and an equipment diagnosis module.

The environment diagnosis module is used for receiving the environmental information detected by the environmental detection module, comparing the received environmental information with the preset environmental conditions, and judging whether there is a fault in the HVAC room according to the comparison result. If there is a fault, the fault information is obtained and sent to the fault alarm unit.

The equipment diagnosis module is used to receive the equipment operation state detected by the equipment detection module, compare the received equipment operation state with the preset equipment operation state, and judge whether there is a fault in the HVAC room according to the comparison result. If there is a fault, the fault information is obtained and sent to the fault alarm unit.

Preferably, the fault alarm unit includes a sound alarm module and a terminal alarm module.

The sound alarm module alerts the fault information by making a sound.

The terminal alarm module is used for sending fault information to the terminal equipment of the mechanical room administrator under the condition that the network is connected to carry out the alarm prompt.

Preferably, it also includes a terminal report unit. The terminal report unit is used for receiving the environmental information sent by the mechanical room inspection unit, the running status of the equipment and the fault information sent by the fault diagnosis unit, forming a report and sending it to the terminal equipment.

The invention relates to an unmanned inspection method of HVAC room based on artificial intelligence, which is based on the unmanned inspection system of HVAC room based on artificial intelligence, which comprises: Through the motion unit, the patrol robot can drive automatically in the HVAC room.

Through the mechanical room inspection unit to detect the environmental information and equipment operation status in the HVAC room.

Through the fault diagnosis unit, the environmental information in the detected HVAC room is compared with the preset environmental conditions, and the running state of the equipment in the tested HVAC room is compared with the preset equipment running state. According to the comparison results, it is judged whether there is a fault in the HVAC room, and if there is a fault, the alarm is given through the fault alarm unit.

Preferably, the environmental information in the HVAC room is detected through the mechanical room inspection unit, which specifically comprises:

The indoor image of the HVAC room is collected through the motion unit.

The mechanical room inspection unit uses the YOLOv5 algorithm to extract the positions of the instruments on the indoor images collected by the motion unit, such as temperature detection equipment, humidity detection equipment, gas detection equipment and noise detection equipment, and uses the ResNet network to identify the data on the instrument to obtain environmental information.

Preferably, the operation status of equipment in the HVAC room is detected through the mechanical room inspection unit, which specifically comprises:

The indoor image of the HVAC room is collected through the motion unit.

The mechanical room inspection unit uses the YOLOv5 algorithm to extract the position of the equipment dashboard, the equipment indicator light and the equipment switch in the indoor image collected by the motion unit. It uses the HoughLines algorithm of the OpenCV algorithm to extract the pointer information in the pointer type dashboard, obtains the data of the pointer type dashboard according to the pointer information, or uses the ResNet network to obtain the data on the digital dashboard to obtain the equipment dashboard data. The YOLOv5 algorithm is used to determine the switch state of the equipment, and the algorithm based on DNB image recognition is used to identify the equipment indicator status.

Compared with the prior art, the invention has the following beneficial effects:

The invention based on artificial intelligence HVAC room unmanned inspection system, through the motion unit to ensure that the patrol robot can automatically drive in the mechanical room. Through the mechanical room inspection unit to obtain the environmental information and equipment status information in the mechanical room. Through the fault diagnosis unit to determine the fault information in the mechanical room. Through the fault alarm unit to timely carry out the fault alarm. Thus, the use of unmanned automatic inspection to carry out the daily mechanical room inspection work can liberate the staff from the tedious and mechanical inspection work, and at the same time, compared with manual inspection, the unmanned automatic inspection system based on artificial intelligence can not only save a lot of manpower and material resources, but also increase the speed and accuracy of inspection and increase the timeliness of inspection. At the same time, the unmanned automatic inspection system based on artificial intelligence can do 24-hour uninterrupted inspection, which makes up for the deficiency that manual inspection cannot be inspected all the time, and can find the faults in the mechanical room in time to ensure that it is in a safe state of movement at all times. In addition, some space is small, the equipment is crowded, personnel detection is difficult, the use of unmanned automatic inspection system is more convenient.

Further, the motion unit in the invention uses a camera to collect indoor images, lidar constructs an indoor map, and carries out path planning according to the map constructed by the lidar in real time and the motion data measured by the inertial sensor. Compared with the traditional inspection robot which needs to carry the motion track, it is more intelligent, the motion track is more abundant, and can effectively improve the speed of movement.

Further, the invention sets up an environment detection module and an equipment detection module. The two modules independently detect the environment information and the running state of the equipment, so that the environment information and the running state of the equipment can be detected and diagnosed independently.

Further, set up a terminal report unit, through which the mechanical room inspection report is generated in real time and sent to the staffs computer or mobile phone for staff to consult and archive.

The invention is based on the unmanned inspection method of HVAC room based on artificial intelligence, which is completed by unmanned automatic inspection, which can not only save a lot of manpower and material resources, but also increase the speed and accuracy of inspection, and increase the timeliness of inspection.

Furthermore, the invention adopts various algorithms to collect environmental information and the running state of the equipment, which can increase the speed and accuracy of detection.

### ILLUSTRATION WITH DRAWINGS

FIG. 1 Composition diagram of the system of the invention

FIG. 2 Automatic driving flow chart of the patrol robot of the invention

FIG. 3 Flow chart of patrol inspection in the computer room of the invention

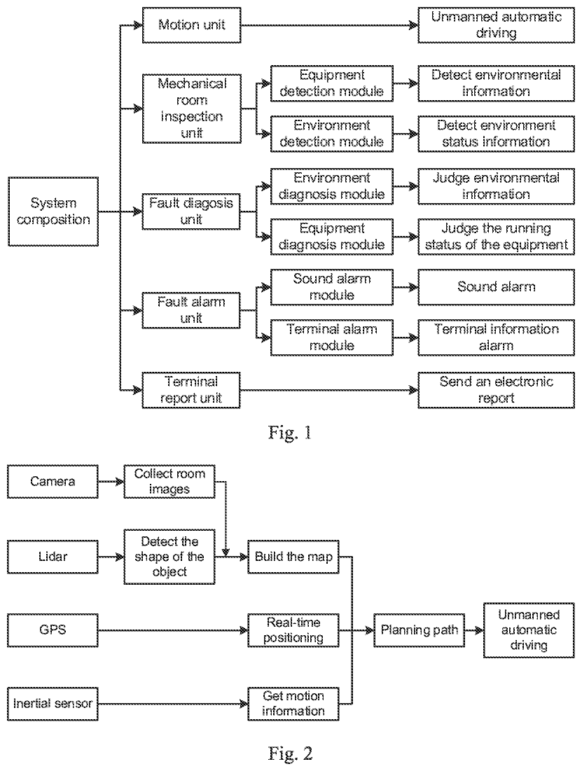

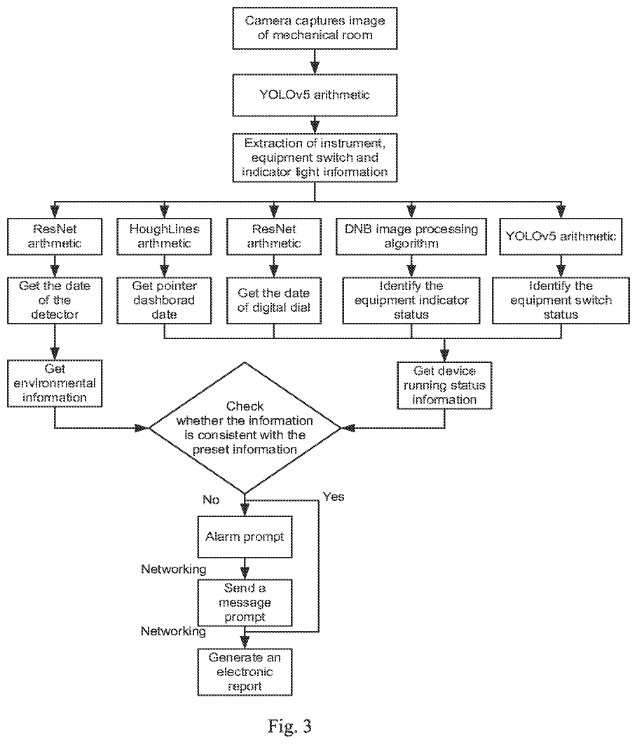

### SPECIFIC IMPLEMENTATION MODE

In order to further understand the invention, the invention is described below in conjunction with an embodiment, which is only a further explanation of the characteristics and advantages of the invention and is not used to limit the claims of the invention.

The invention is based on the unmanned inspection system of HVAC room based on artificial intelligence, which specifically comprises a patrol robot, a motion unit, a mechanical room inspection unit, a fault diagnosis unit, a fault alarm unit and a terminal report unit.

The motion unit is used to ensure that the patrol robot can realize unmanned automatic driving in the HVAC room. The motion unit is used for collecting the images inside the computer room, detecting the shape of the objects around the mechanical room, establishing the map of the mechanical room and implementing the location of the patrol robot. The motion unit includes a motion control unit, a camera, a lidar, a GPS and an inertial sensor.

The mechanical room inspection unit is mainly used to detect the environmental information and equipment operation status of the HVAC room, and transmit the detected information to the fault diagnosis unit. The mechanical room inspection unit mainly includes an environmental detection module and an equipment detection module.

The environmental detection module is used for reading the parameters displayed on the temperature, humidity, gas and noise detection devices in the HVAC room, so as to determine the environmental information in the HVAC room. There are a large number of equipment in the HVAC room, which are very sensitive to temperature, humidity and gas dust. Once these environmental parameters exceed the standard range of the mechanical room, there will be great hidden dangers, which may cause equipment short-circuit, fire and other failures, affecting the stable operation of the mechanical room. When there is a fault in the equipment, sometimes noise will be generated. For example, if the hydraulic imbalance of the pipeline, it will lead to excessive local flow velocity in the pipeline, thus increasing the local noise. Therefore, in general, temperature, humidity, gas and noise detection devices are installed in the equipment-intensive areas of the mechanical room in order to detect the environmental information in the HVAC room in real time. The equipment detection module is mainly used to detect the running state of the equipment in the HVAC room, including the equipment indicator status, the equipment switch status, the equipment dashboard data and the equipment surface temperature.

The fault diagnosis unit is used for receiving the environmental information and equipment operation status detected by the mechanical room inspection unit, and comparing the received information with the preset information, so as to judge whether there is a fault in the HVAC room. The fault diagnosis unit includes an environment diagnosis module and an equipment diagnosis module. The environmental diagnosis module is used to judge whether the environmental information of the HVAC room meets the preset conditions, and the equipment diagnosis module is used to judge whether the running state of the equipment meets the preset conditions. The environment diagnosis module and the equipment diagnosis module run separately and do not interfere with each other. When the fault diagnosis unit only receives the environmental information, the environment diagnosis module runs independently. When the fault diagnosis unit only receives the running state of the equipment, the equipment diagnosis module runs independently. When the environmental information and the running state of the equipment are received at the same time, both run at the same time. For example, to judge whether the environmental information of the mechanical room meets the preset conditions. For example, if the ambient temperature in the mechanical room is within the preset temperature range, it is determined that the temperature of the mechanical room is normal. If it is outside the preset temperature range, it is determined that the temperature of the mechanical room is abnormal, which means, there is a fault in the computer room. Judge whether the running state of the equipment in the mechanical room meets the preset conditions. If the indicator color of the equipment is consistent with the preset color, it will be judged that the equipment is running normally. If the color is not consistent, it will be judged as abnormal operation of the equipment, which means, there is a fault in the mechanical room.

The fault alarm unit is used for alerting the fault information. The fault alarm unit includes a sound alarm module and a terminal alarm module. The sound alarm module adopts an alarm, which makes a sound through the alarm, and the fault information carries on the alarm prompt. The terminal alarm module is used for sending fault information to the mobile phone or computer of the computer room administrator when the network is connected, so as to prompt the alarm.

The terminal report unit is used for receiving the information detected by the computer room patrol inspection unit and the fault diagnosis unit, and in the case of connecting the network, the computer room information (environment information, equipment operation status, fault information) obtained by each inspection is sent to the mechanical room administrator's mobile phone or computer in the form of an electronic report for reading and archiving.

The motion unit, the mechanical room inspection unit and the fault diagnosis unit are installed on the patrol robot, and the fault alarm unit is installed in the HVAC room. The terminal report unit is installed on the terminal equipment.

The camera is used to collect the indoor image of the HVAC room, so that the motion unit can build the indoor map according to the indoor image, and the computer room inspection unit uses the corresponding algorithm to collect the environmental information of the computer room and the running state of the equipment according to the indoor image.

The lidar uses visible light and near infrared light to transmit signals, which are collected after reflected by the target, and the distance of the target is determined by the running time of the reflected light, so that the shape of the object around the computer room can be detected. At the same time, the lidar can construct an indoor map according to the indoor image captured by the camera.

The time T of the same laser signal from the transmitting tube to the receiving tube is calculated inside the lidar. Therefore, it can be calculated that the distance between the lidar and the surrounding object D is:

$$D = \frac{CT}{2} ∘$$

The C is a constant representing the speed of light. C=299792458 m/s°

GPS is used to provide real-time and accurate position information of patrol robots.

The inertial sensor is used to detect and measure the motion data of the patrol robot, including acceleration, tilt, impact, vibration, rotation and multi-degree-of-freedom motion, so as to determine the attitude and trajectory of the patrol robot.

The motion control unit adopts a three-dimensional obstacle avoidance algorithm, and carries out path planning according to the indoor map constructed by the lidar in real time and the motion data measured by the inertial sensor, so that the inspection robot can avoid obstacles such as equipment in the computer room. to achieve unmanned self-driving.

The environment detection module receives the image information collected by the camera in the motion unit, uses the YOLOv5 algorithm to extract the position of the instrument on the temperature, humidity, gas and noise detection equipment in the image. Uses the ResNet network to identify the data on the instrument, thus reading the data on the temperature, humidity, gas and noise detection equipment. The equipment detection module receives the image information collected by the camera, according to the image information collected by the camera. Uses the YOLOv5 algorithm to extract the position of the dashboard, indicator light and device switch in the image, and uses the HoughLines algorithm of the OpenCV algorithm to extract the pointer information in the pointer dashboard, so as to obtain the data of the pointer dashboard according to the pointer information. The ResNet network is used to obtain the data on the digital dashboard, so as to realize the data reading of the equipment dashboard.

The HoughLines algorithm of OpenCV algorithm is used to extract the pointer information in the pointer dashboard. The OpenCV algorithm is used to extract the line segment, record the coordinates of the two ends of the line segment (x1,y1), (x2,y2) and the angle between the horizontal direction 9, so as to determine the position of the scale line, and calculate the data on the dashboard according to the formula

$$M = {I}_{0} \times \frac{α}{β .}$$

Where α represents the range angle, β represents the angle between the pointer and the zero scale, and I0 represents the total range of the dashboard.

The equipment detection module in the mechanical room inspection unit uses the YOLOv5 algorithm to determine the state of the equipment switch. The switching states of general equipment are horizontal, lateral and longitudinal.

The equipment detection module in the computer room inspection unit adopts an algorithm based on DNB image recognition to identify the state of the indicator light. The color of the indicator light is generally red, yellow and green. According to the image recognition algorithm:

$$Color = \{ \begin{matrix}Green , DBNvalue ∈ [ 0.75 , 0.85 ] \\ Red , DBNvalue ∈ [ 0.34 , 0.45 ] \\ Yellow , DBNvalue ∈ ( 0.45 , 0.55 ] \\ Unrecognized , OthersDBNvalues\end{matrix}$$

The status of the indicator can be identified according to the size of the evaluation.

The mechanical room inspection unit uses an infrared thermal imager to measure the surface temperature of the equipment, and the infrared thermal imager is mounted on the patrol robot.

What is claimed is:

1. An unmanned inspection system for HVAC room based on artificial intelligence is characterized in that it includes a patrol robot, a motion unit, a mechanical room inspection unit, a fault diagnosis unit, a fault alarm unit and a terminal report unit. The motion unit, the mechanical room inspection unit and the fault diagnosis unit are installed on the patrol robot, and the fault alarm unit is installed in the HVAC room. The terminal report unit is installed on the terminal equipment;
the motion unit is used to realize the automatic driving of the inspection robot;
the mechanical room inspection unit is used to detect the environmental information and the running status of the equipment in the HVAC room and send it to the fault diagnosis unit;
the fault diagnosis unit is used for receiving the environmental information and equipment running state detected by the mechanical room patrol inspection unit, and comparing the received environmental information with the preset environmental conditions. The operation state of the received equipment is compared with the preset equipment operation state, and whether there is a fault in the HVAC room is judged according to the comparison result. If there is a fault, the fault information is obtained and sent to the fault alarm unit. The fault alarm unit is used for alerting the fault information.

2. The unmanned inspection system of HVAC room based on artificial intelligence according to claim 1 is characterized in that the motion unit includes a motion control unit, a camera, a lidar, a GPS and an inertial sensor;
the camera is used for collecting indoor images of the HVAC room;
the lidar is used to detect the shape of the object in the HVAC room, and the indoor map is constructed according to the indoor image captured by the camera;
the GPS is used to collect position information of patrol robot;
the inertial Sensor is used to measure the motion data of Patrol Robot during motion;
the motion control unit adopts a three-dimensional obstacle avoidance algorithm, and carries out path planning according to the indoor map constructed by lidar, the position information of the patrol robot collected by GPS and the motion data of the patrol robot measured by inertial sensors, so that the patrol robot can drive automatically.

3. The unmanned inspection system of HVAC room based on artificial intelligence according to claim 1 is characterized in that the mechanical inspection unit of the room includes an environment detection module and an equipment detection module;
the environment detection module is used to detect the temperature, humidity, gas and noise information in the HVAC room, and get the environmental information;
the equipment detection module is used to detect the operation status of the equipment in the HVAC room, including the equipment indicator status, the equipment switch status, the equipment dashboard data and the equipment surface temperature.

4. The unmanned inspection system of HVAC room based on artificial intelligence according to claim 3 is characterized in that the equipment detection module includes an infrared thermal imager;
the infrared thermal imager is mounted on the inspection robot and is used to measure the surface temperature of the equipment.

5. The unmanned inspection system of HVAC room based on artificial intelligence according to claim 3 is characterized in that the fault diagnosis unit includes an environment diagnosis module and an equipment diagnosis module. The environment diagnosis module is used for receiving the environmental information detected by the environmental detection module, comparing the received environmental information with the preset environmental conditions, and judging whether there is a fault in the HVAC room according to the comparison result. If there is a fault, the fault information is obtained and sent to the fault alarm unit;
the equipment diagnosis module is used to receive the equipment operation state detected by the equipment detection module, compare the received equipment operation state with the preset equipment operation state, and judge whether there is a fault in the HVAC room according to the comparison result. If there is a fault, the fault information is obtained and sent to the fault alarm unit.

6. The unmanned inspection system of HVAC room based on artificial intelligence according to claim 1 is characterized in that the fault alarm unit includes a sound alarm module and a terminal alarm module;
the sound alarm module alerts the fault information by making a sound;
the terminal alarm module is used for sending fault information to the terminal equipment of the mechanical room administrator under the condition that the network is connected to carry out the alarm prompt.

7. The unmanned inspection system of HVAC room based on artificial intelligence according to claim 1 is characterized in that it also includes a terminal report unit. The terminal report unit is used for receiving the environmental information sent by the mechanical room inspection unit, the running status of the equipment and the fault information sent by the fault diagnosis unit, forming a report and sending it to the terminal equipment.

8. The invention relates to an unmanned inspection method for HVAC room base on artificial intelligence, which is characterized in that the unmanned inspection system for HVAC room based on artificial intelligence, comprises:
through the motion unit, the patrol robot can drive automatically in the HVAC room;
through the mechanical room inspection unit to detect the environmental information and equipment operation status in the HVAC room;
through the fault diagnosis unit, the environmental information in the detected HVAC room is compared with the preset environmental conditions, and the running state of the equipment in the tested HVAC room is compared with the preset equipment running state. According to the comparison results, it is judged whether there is a fault in the HVAC room, and if there is a fault, the alarm is given through the fault alarm unit.

9. The unmanned inspection method of HVAC room based on artificial intelligence according to claim 8 is characterized in that the environmental information in the HVAC room is detected through the mechanical room inspection unit, which specifically comprises:
the indoor image of the HVAC room is collected through the motion unit;
the mechanical room inspection unit uses the YOLOv5 algorithm to extract the positions of the instruments on the indoor images collected by the motion unit, such as temperature detection equipment, humidity detection equipment, gas detection equipment and noise detection equipment, and uses the ResNet network to identify the data on the instrument to obtain environmental information.

10. The unmanned inspection method of HVAC room based on artificial intelligence according to claim 8 is characterized in that the operation status of equipment in the HVAC room is detected through the mechanical room inspection unit, which specifically comprises:
the indoor image of the HVAC room is collected through the motion unit;
the mechanical room inspection unit uses the YOLOv5 algorithm to extract the position of the equipment dashboard, the equipment indicator light and the equipment switch in the indoor image collected by the motion unit. It uses the HoughLines algorithm of the OpenCV algorithm to extract the pointer information in the pointer type dashboard, obtains the data of the pointer type dashboard according to the pointer information, or uses the ResNet network to obtain the data on the digital dashboard to obtain the equipment dashboard data. The YOLOv5 algorithm is used to determine the switch state of the equipment, and the algorithm based on DNB image recognition is used to identify the equipment indicator status.
